(19) United States
(12) Patent Application Publication
(10) Pub. No.: US 2016/0319871 A1
(43) Pub. Date: Nov. 3, 2016

(54) BEARING ASSEMBLY WITH FORMED RACEWAYS

(71) Applicant: Schaeffler Technologies AG & Co. KG, Herzogenaurach (DE)

(72) Inventor: John TATE, Cornelius, NC (US)

(73) Assignee: SCHAEFFLER TECHNOLOGIES AG & CO. KG, Herzogenaurach (DE)

(21) Appl. No.: 14/699,035

(22) Filed: Apr. 29, 2015

(51) Int. Cl. F16C 33/58; F16C 19/06

(52) U.S. Cl. CPC F16C 33/588; F16C 19/06

(57) ABSTRACT

A bearing assembly including a formed raceway in a metal sheet is provided. The bearing assembly includes a plurality of spherical rolling elements and a thin-walled bearing ring. The thin-walled bearing ring is comprised of a metal sheet having a raceway formed in the metal sheet on which the plurality of spherical rolling elements run. A portion of the metal sheet opposite the raceway protrudes beyond a thickness of the metal sheet.

### FIELD OF INVENTION

This invention is generally related to a bearing assembly and more particularly related to low height ball bearings as well as a retention feature for a bearing ring of a bearing assembly.

### BACKGROUND

Bearing assemblies are widely used in a variety of applications. Radial bearing assemblies with spherical rolling elements typically require greater radial space than needle roller bearings due to the shape of the spherical rolling elements and machined raceways. Due to space constraints, it is generally desirable to minimize the radial installation space required for the bearing ring to minimize the overall size of an assembly. Depending on the particular application, bearing assemblies may require retention features to secure at least one of the bearing rings against a housing, shaft, or other component. Known retention features require additional radial space to secure the bearing ring.

Depending on the operating temperature, bearings can disengage from retention features. Bearing rings may expand and contract, which can cause the bearing ring to disengage from an associated retention feature or a support element. Also, for bearing assemblies mounted in housings formed from metal alloys, these metal alloy housings can also experience a high degree of thermal expansion based on the operating temperature, which may cause the bearing assembly to disengage from the support element.

### SUMMARY

It would be desirable to provide a compact bearing assembly as well as to provide a retention feature that provides reliable retention of an associated bearing ring in a range of operating temperatures.

A compact bearing assembly including a formed raceway is provided. The bearing assembly includes a plurality of spherical rolling elements and a thin-walled bearing ring. The thin-walled bearing ring is comprised of a metal sheet having a formed raceway in the metal sheet on which the plurality of spherical rolling elements run. A portion of the metal sheet opposite the raceway protrudes beyond a thickness of the metal sheet.

In one embodiment, a polymeric ring is arranged on an opposite side of the bearing ring from the raceway and can provide retention of the bearing ring with respect to the other components of the bearing assembly, as well as support for the thin-walled bearing ring. The polymeric ring reduces or eliminates fretting that occurs in known bearing assemblies including steel bearing surfaces. Fretting generates particles which eventually wear on the bearing surfaces, reducing the efficiency of the bearing assembly.

Preferred arrangements with one or more features of the invention are described below and in the claims.

### BRIEF DESCRIPTION OF THE DRAWINGS

The foregoing Summary as well as the following Detailed Description will be best understood when read in conjunction with the appended drawings. In the drawings:

FIG. 1 shows a cross-section view of a bearing assembly according to a first embodiment of the invention.

FIG. 2 shows a cross-section view of a bearing assembly according to a second embodiment of the invention.

FIG. 3 shows a cross-section view of a bearing assembly according to a third embodiment of the invention.

FIG. 4 shows a cross-section view of a bearing assembly according to a fourth embodiment of the invention.

FIG. 5 shows a cross-section view of a bearing assembly according to a fifth embodiment of the invention.

FIG. 6 shows a cross-section view of a bearing assembly according to a sixth embodiment of the invention.

FIG. 7 shows a cross-section view of a bearing assembly according to a seventh embodiment of the invention.

### DETAILED DESCRIPTION OF THE PREFERRED EMBODIMENTS

Certain terminology is used in the following description for convenience only and is not limiting. The words “inner,” “outer,” “inwardly,” and “outwardly” refer to directions towards and away from the parts referenced in the drawings. A reference to a list of items that are cited as “at least one of a, b, or c” (where a, b, and c represent the items being listed) means any single one of the items a, b, c or combinations thereof. The terminology includes the words specifically noted above, derivates thereof, and words of similar import.

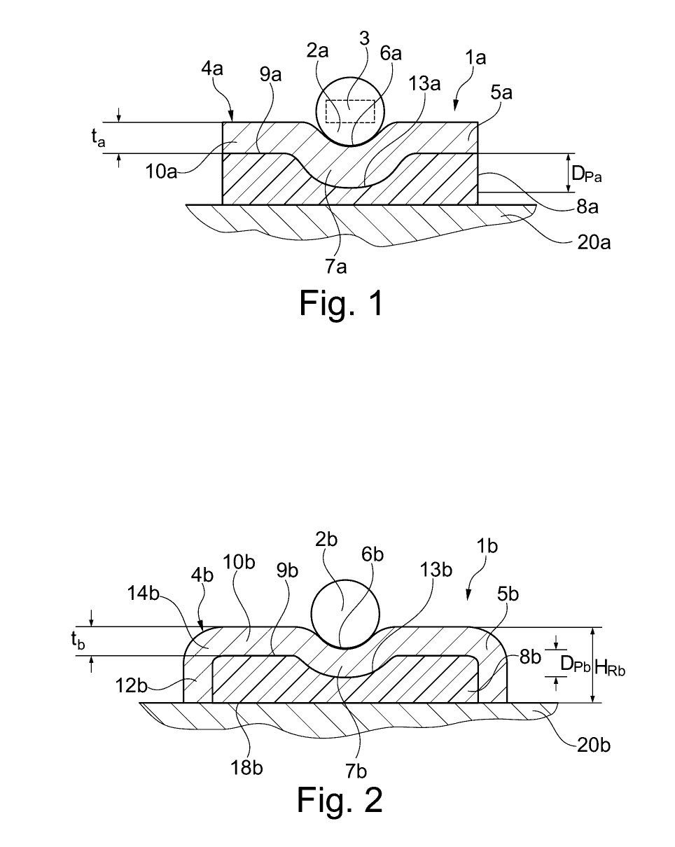

As shown in FIGS. 1-7, bearing assemblies 1a-1g with formed raceways 6a-6g are provided. The bearing assemblies 1a-1g each include a plurality of spherical rolling elements 2a-2g. The bearing assemblies 1a-1g include a thin-walled bearing ring 4a-4g comprised of a metal sheet 5a-5g with a formed raceway 6a-6g in the metal sheet 5a-5g on which the plurality of spherical rolling elements 2a-2g run. A cage 3 is shown in phantom lines in FIG. 1 for guiding the spherical rolling elements 2a. One of ordinary skill in the art would recognize that a cage could also be provided in the embodiments shown in FIGS. 2-7. The formed raceways 6a-6g are preferably formed via drawing, stamping, punching, ring rolling, or a combination thereof. The metal sheet 5a-5g is preferably formed from bearing grade strip steel, which can have a thickness, for example, in the range of 0.039-0.125 inches. However, the thickness can vary depending on the particular application. A portion 7a-7e, 7g of the metal sheet 5a-5e, 5g opposite from the raceway 6a-6e, 6g protrudes beyond a thickness tₐ, t_{b}, t_{c}, t_{d}, tₑ, t_{g} of the metal sheet 5a-5e, 5g. As shown in FIGS. 2, 3, and 5, the bearing ring 4b, 4c, 4e may have an M-shaped profile when viewed in a circumferential direction. One of ordinary skill in the art would recognize that other profiles can be used to minimize the overall radial height of the bearing ring.

As shown in FIGS. 1-6, the bearing assemblies 1a-1f include a polymeric ring 8a-8f arranged on an opposite side of the bearing ring 4a-4f from the raceway 6a-6f. The polymeric ring 8a-8f is preferably formed from a thermoplastic material. In one embodiment, the polymeric ring 8a-8f is formed from a rubber material. The polymeric ring 8a-8f is preferably supported between the bearing ring 4a-4f and a support component 20a-20f, i.e. a shaft or housing. The polymeric ring 8a-8f acts as a retention feature for the bearing ring 4a-4f to prevent the bearing ring 4a-4f from moving once the bearing assembly 1a-1f is installed. The polymeric ring 8a-8f may also act to stabilize and support the thin-walled bearing ring. The polymeric ring 8a-8f includes a radial surface 9a-9f opposite from the support component 20a-20f that is complementarily shaped to an opposing radial surface 13a-13f of the bearing ring 4a-4f.

In the embodiments shown in FIGS. 1-5 and 7, the thin-walled bearing ring 4a-4e, 4g includes axially extending portions 10a-10e, 10g on both sides of the raceway 6a-6e, 6g. As shown in FIGS. 2-5, the thin-walled bearing ring 4b-4e includes radially extending flanges 12b-12e extending from ends 14b-14e of the axially extending portions 10b-10e.

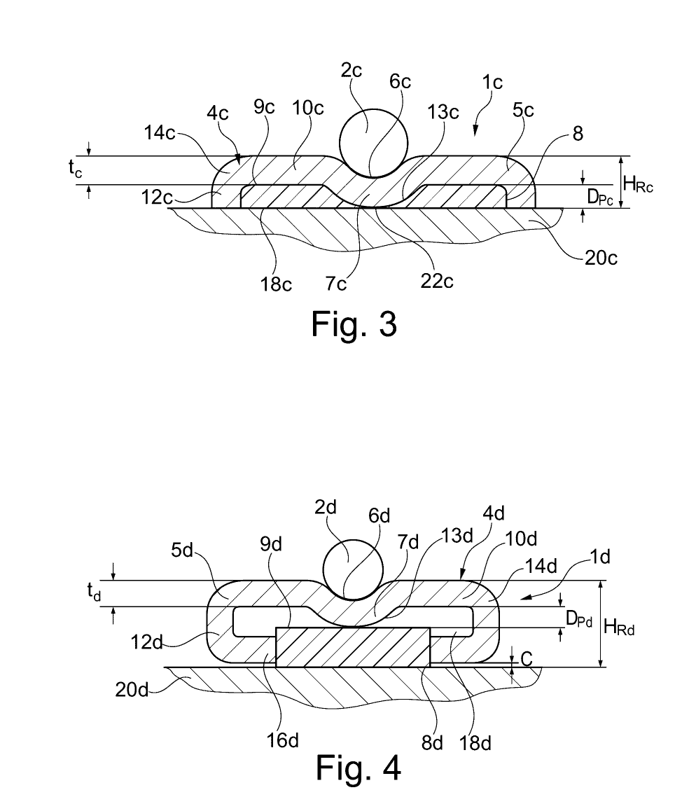

A third embodiment of the bearing assembly 1c is shown in FIG. 3. As shown in FIG. 3, zero clearance is provided between (1) a radial outer surface 22c of the support component 20c and (2) a maximum depth of the protrusion of the raceway 6c. As shown in FIG. 3, the radial height H_{Rc} of the radially extending flanges 12c is equal to the thickness t_{c} of the thin-walled metal sheet 5c plus the depth D_{Pc} that the portion 7c of the thin-walled bearing ring 4c opposite the raceway 6c protrudes beyond the thickness t_{c} of the metal sheet 5c.

A fourth embodiment of the bearing assembly 1d shown in FIG. 4 includes radial flanges 12d having axially extending return flanges 16d. As shown in FIG. 4, the polymeric ring 8d engages the support component 20d and a clearance (c) is provided between the axially extending return flanges 16d and the support component 20d. Axial ends of the axially extending return flanges 16d engage axial sides of the polymeric ring 8d.

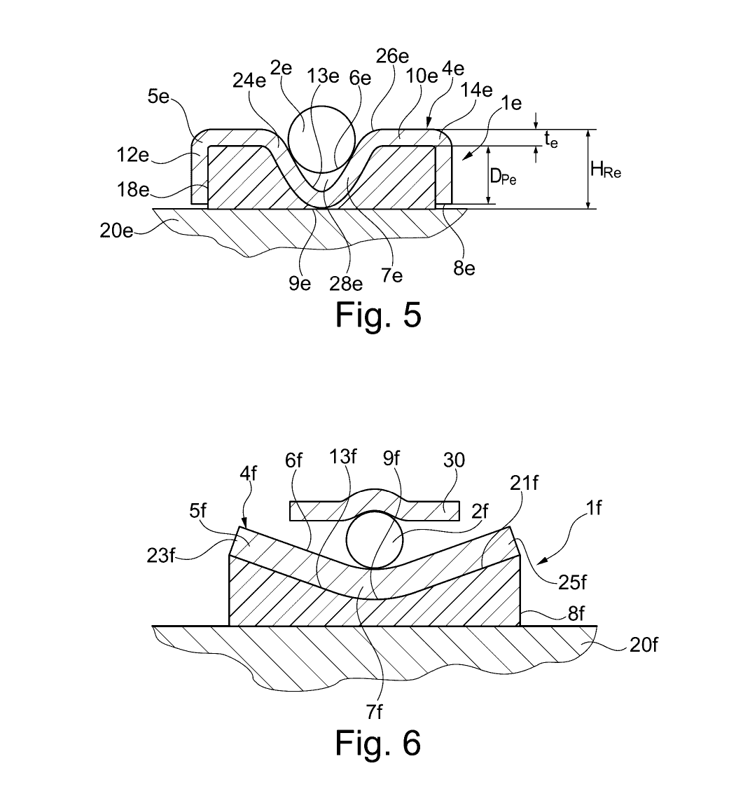

A fifth embodiment of the bearing assembly 1e shown in FIG. 5 includes a raceway 6e that contacts each one of the plurality of spherical rolling elements 2e at at least two contact areas 24e, 26e. The at least two contact areas 24, 26e are spaced apart from each other, and a gap 28e is provided between the raceway 6e and the plurality of spherical rolling elements 2e between the at least two contact areas 24e, 26e.

As shown in FIGS. 2-5, the radially extending flanges 12b-12e have a radial height H_{Rb}, H_{Rc}, H_{Rd}, H_{Re} equal to or greater than a total of (1) the thickness t_{b}, t_{c}, t_{d}, tₑ of the metal sheet 5b-5e, and (2) a depth D_{Pb} D_{Pc}, D_{Pd}, D_{Pe} that the portion 7b-7e of the thin-walled bearing ring 4b-4e opposite the raceway 6b-6e protrudes beyond the thickness t_{b}, t_{c}, t_{d}, tₑ of the metal sheet 5b-5e. The radial height H_{Rb}, H_{Rc}, H_{Rd}, H_{Re} of the radially extending flanges 12b-12e is minimized so the overall radial height of the bearing assemblies 1b-1e is minimized.

As shown in FIGS. 2-5, the radially extending flanges 12b-12e define a circumferentially extending channel 18b-18e. As shown in the embodiments of FIGS. 2, 3, and 5, the channel 18b, 18c, 18e is completely filled by the polymeric ring 8b, 8c, 8e. As shown in the embodiment of FIG. 4, the channel 18d can also only be partially filled by the polymeric ring 8d.

A sixth embodiment of the bearing assembly 1f is shown in FIG. 6. In this bearing assembly 1f, the raceway 6f of the bearing ring 4f is defined in cross-section on a radial surface 21f having a continuous curvature between axial ends 23f, 25f of the bearing ring 4f. The bearing assembly 1f includes a secondary thin-walled bearing ring 30 formed from a metal sheet and including a formed raceway arranged on an opposite side of the spherical rolling elements 2f from the thin-walled bearing ring 4f. Although the secondary thin-walled bearing ring 30 is only shown in FIG. 6, one of ordinary skill in the art would recognize that a corresponding secondary bearing ring would also be provided in the embodiments shown in FIGS. 1-5 and 7. The secondary thin-walled bearing rings can include an identical size and arrangement as the bearing rings 4a-4e, 4g, or a different configuration than the bearing rings 4a-4e, 4g.

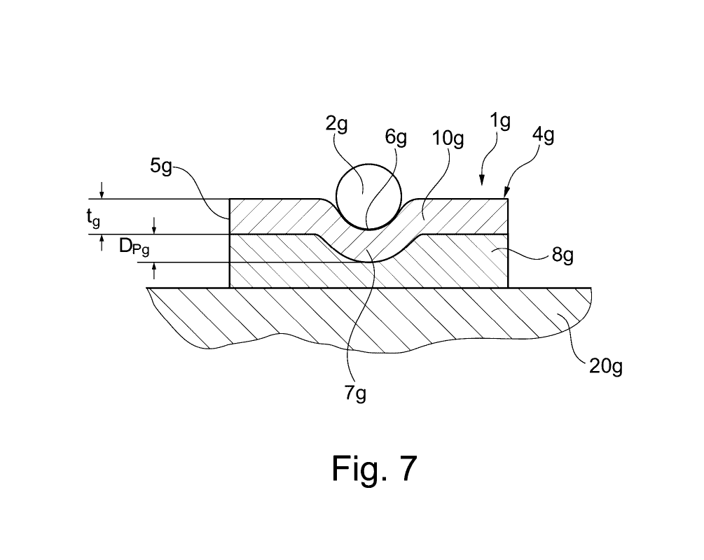

In a seventh embodiment of the bearing assembly 1g shown in FIG. 7 the bearing assembly 1g includes a retention ring 8g formed from a high carbon steel. In this embodiment, the retention ring 8g is supported between the bearing ring 4g and the support component 20g. The retention ring 8g is complementarily shaped to the bearing ring 4g and is snapped onto the bearing ring 4g.

Having thus described various embodiments of the present bearing assembly in detail, it is to be appreciated and will be apparent to those skilled in the art that many changes, only a few of which are exemplified in the detailed description above, could be made in the device without altering the inventive concepts and principles embodied therein. The present embodiments are therefore to be considered in all respects as illustrative and not restrictive, the scope of the invention being indicated by the appended claims rather than by the foregoing description, and all changes which come within the meaning and range of equivalency of the claims are therefore to be embraced therein.

What is claimed is:

1. A bearing assembly comprising:
a plurality of spherical rolling elements; and
a thin-walled bearing ring comprised of a metal sheet having a formed raceway in the metal sheet on which the plurality of spherical rolling elements run, a portion of the metal sheet opposite the raceway protruding beyond a thickness of the metal sheet.

2. The bearing assembly of claim 1, further comprising a polymeric ring arranged on an opposite side of the bearing ring from the raceway.

3. The bearing assembly of claim 1, wherein the thin-walled bearing ring includes axially extending portions on both sides of the raceway.

4. The bearing assembly of claim 3, wherein the thin-walled bearing ring includes radially extending flanges extending from ends of the axially extending portions.

5. The bearing assembly of claim 4, wherein the radially extending flanges have a radial height equal to or greater than a total of (1) the thickness of the sheet metal, and (2) a depth that the portion of the metal sheet opposite the raceway protrudes beyond the thickness of the metal sheet.

6. The bearing assembly of claim 4, wherein the radial flanges have axially extending return flanges.

7. The bearing assembly of claim 4, wherein the radially extending flanges define a circumferentially extending channel.

8. The bearing assembly of claim 7, wherein the channel is completely filled by a polymeric ring arranged on an opposite side of the bearing ring from the raceway.

9. The bearing assembly of claim 7, wherein the channel is partially filled by a polymeric ring arranged on an opposite side of the bearing ring from the raceway.

10. The bearing assembly of claim 1, wherein the bearing ring has an M-shaped cross-sectional profile when viewed in a circumferential direction.

11. The bearing assembly of claim 1, wherein the metal sheet is formed from strip steel.

12. The bearing assembly of claim 2, wherein the polymeric ring is formed from a thermoplastic material.

13. The bearing assembly of claim 12, wherein the polymeric ring includes a radial surface on a radial side opposite from a support component that is complementarily shaped to an opposing radial surface of the bearing ring.

14. The bearing assembly of claim 1, wherein the raceway of the bearing ring is defined in cross-section on a radial surface including a continuous curvature between axial ends of the bearing ring.

15. The bearing assembly of claim 1, wherein zero clearance is provided between (1) a radial outer surface of the support component and (2) a maximum depth of the raceway of the bearing ring.

16. The bearing assembly of claim 1, wherein the raceway contacts each one of the plurality of rolling elements at at least two contact areas that are spaced apart from each other, and a gap is provided between the raceway and the plurality of rolling elements between the at least two contact areas.

17. A bearing assembly comprising:
a plurality of spherical rolling elements;
a thin-walled bearing ring comprised of a metal sheet having a formed raceway in the metal sheet on which the plurality of rolling elements run, a portion of the metal sheet opposite the raceway protruding beyond a thickness of the metal sheet; and
a metal retention ring arranged on an opposite side of the bearing ring from the raceway.

18. The bearing assembly of claim 17, wherein the retention ring is formed from a high carbon steel.
